(19) United States
(12) Patent Application Publication
(10) Pub. No.: US 2016/0094599 A1
(43) Pub. Date: Mar. 31, 2016

(54) HANDLING NETWORK CONNECTION CHANGES DURING ADAPTIVE BITRATE STREAMING

(71) Applicants: Alcatel-Lucent USA Inc., Murray Hill, NJ (US); Alcatel Lucent, Boulogne-Billancourt (FR)

(72) Inventors: Kamakshi Sridhar, Plano, TX (US); Dave C. Robinson, Aldbourne (GB)

(73) Assignees: ALCATEL LUCENT, Boulogne-Billancourt (FR); ALCATEL-LUCENT USA INC., Murray Hill, NJ (US)

(21) Appl. No.: 14/501,217

(22) Filed: Sep. 30, 2014

(51) Int. Cl. H04L 29/06; H04W 40/36

(52) U.S. Cl. CPC H04L 65/60; H04W 40/36

(57) ABSTRACT

A capability for handling network connection changes during adaptive bitrate streaming is provided. A method includes receiving a request for a change associated with a network connection of a client device where the network connection of the client device is configured to support delivery of a content item to the client device using an adaptive bitrate streaming process of the client device, and delaying the change associated with the network connection of the client device based on a state of the adaptive bitrate streaming process. A method includes detecting that a chunk of a content item, requested by an adaptive bitrate streaming process of a client device via a network connection of the client device, has been received at the client device, and delaying a request for a next chunk of the content item based on a state of a change associated with the network connection of the client device.

### TECHNICAL FIELD

The disclosure relates generally to communication networks and, more specifically but not exclusively, to handling of network connection changes during adaptive bitrate streaming via communication networks.

### BACKGROUND

The use of adaptive bitrate streaming to deliver content items to client devices continues to grow. While the use of adaptive bitrate streaming to deliver content items to client devices tends to provide improved quality of experience (QoE) for users of the client devices, existing adaptive bitrate streaming techniques may still result in insufficient QoE for users of the client devices under certain conditions.

### SUMMARY OF EMBODIMENTS

Various deficiencies in the prior art may be addressed by embodiments for supporting handling of network connection changes during adaptive bitrate streaming.

In at least some embodiments, a client device includes a processor and a memory communicatively connected to the processor. The processor is configured to receive a request for a change associated with a network connection of the client device, wherein the network connection of the client device is configured for supporting delivery of a content item to the client device using an adaptive bitrate streaming process of the client device. The processor is configured to delay the change associated with the network connection of the client device based on a state of the adaptive bitrate streaming process of the client device.

In at least some embodiments, a method includes using a processor and a memory for receiving a request for a change associated with a network connection of a client device wherein the network connection of the client device is configured for supporting delivery of a content item to the client device using an adaptive bitrate streaming process of the client device, and delaying the change associated with the network connection of the client device based on a state of the adaptive bitrate streaming process of the client device.

In at least some embodiments, a client device includes a processor and a memory communicatively connected to the processor. The processor is configured to detect that a chunk of a content item, requested by an adaptive bitrate streaming process of the client device via a network connection of the client device, has been received at the client device. The processor is configured to delay a request for a next chunk of the content item based on a state of a change associated with the network connection of the client device.

In at least some embodiments, a method includes using a processor and a memory for detecting that a chunk of a content item, requested by an adaptive bitrate streaming process of a client device via a network connection of the client device, has been received at the client device, and delaying a request for a next chunk of the content item based on a state of a change associated with the network connection of the client device.

### BRIEF DESCRIPTION OF THE DRAWINGS

The teachings herein can be readily understood by considering the following detailed description in conjunction with the accompanying drawings, in which:

FIG. 1 depicts an exemplary communication system configured to handle network connection changes during adaptive bitrate streaming;

FIG. 2 depicts an exemplary embodiment of a method for handling a network connection change during adaptive bitrate streaming;

FIG. 3 depicts an exemplary embodiment of a method for handling a network connection change during adaptive bitrate streaming; and

FIG. 4 depicts a high-level block diagram of a computer suitable for use in performing functions described herein.

To facilitate understanding, identical reference numerals have been used, where possible, to designate identical elements common to the figures.

### DETAILED DESCRIPTION OF EMBODIMENTS

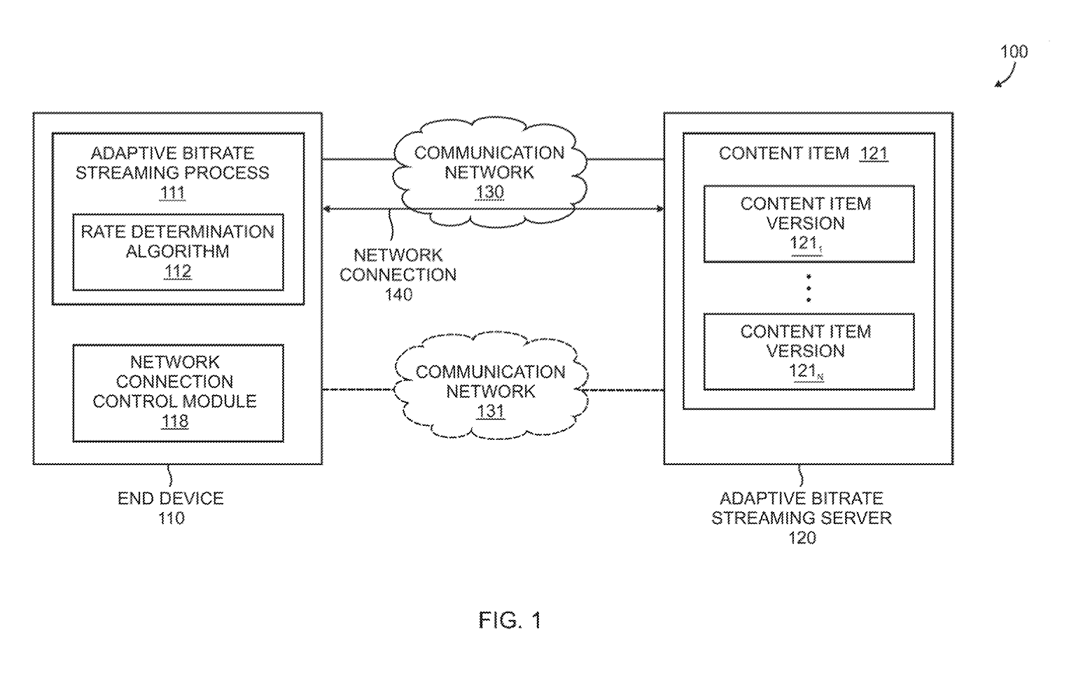

In general, a capability for handling network connection changes during adaptive bitrate streaming is provided. In at least some embodiments, the capability for handling network connection changes during adaptive bitrate streaming includes receiving a request for a change associated with a network connection of a client device wherein the network connection of the client device is configured to support delivery of a content item to the client device using an adaptive bitrate streaming process of the client device and delaying the change associated with the network connection of the client device based on a state of the adaptive bitrate streaming process of the client device. In at least some embodiments, the capability for handling network connection changes during adaptive bitrate streaming includes detecting that a chunk of a content item, requested by an adaptive bitrate streaming process of a client device via a network connection of the client device, has been received at the client device, and delaying a request for a next chunk of the content item based on a state of a change associated with the network connection of the client device. These and various other embodiments and advantages of the capability for handling network connection changes during adaptive bitrate streaming may be further understood when considered within the context of an exemplary communication system supporting adaptive bitrate streaming, as depicted in FIG. 1.

FIG. 1 depicts an exemplary communication system configured to handle network connection changes during adaptive bitrate streaming.

The communication system 100 includes a client device 110 (e.g., an end device or any other suitable type of client device) and an adaptive bitrate streaming server 120 configured to communicate via a communication network 130. The client device 110 includes an adaptive bitrate streaming process 111, which supports a rate determination algorithm 112. The adaptive bitrate streaming process 111 may be part of an adaptive bitrate streaming client (omitted for purposes of clarity) of the client device 110. The client device 110 also includes a network connection control module 118. The adaptive bitrate streaming server 120 stores a content item 121 as a set of content item versions 121₁-121_{N} available for use in delivering the content item 121 to the client device 110 using adaptive bitrate streaming. The content item 121 may be an audio content item, a video-based content item (e.g., video only, multimedia, or the like), a multimedia content item, or any other suitable form of content which may be streamed via communication network 130 using adaptive bitrate streaming.

The client device 110 and the adaptive bitrate streaming server 120 are configured to cooperate to support adaptive bitrate streaming (which also may be referred to as adaptive streaming) of the content item 121 from the adaptive bitrate streaming server 120 to the client device 110 for presentation via the client device 110. The content item versions 121₁-121_{N} are different versions of content item 121 that have been encoded at N different bitrates (and, thus, represent N different quality levels of content item 121). It is noted that there may be variations in bitrates of chunks within a given content item version 121ᵢ (e.g., due to different portions (e.g., scenes) of the content item 121 needing more or less bits than other portions (e.g., scenes) of the content item 121, such as where scenes with relatively high levels of motion may need additional bits for encoding). The content item versions 121₁-121_{N} are each segmented into segments or chunks (e.g., typically between two and ten seconds each, although shorter or longer chunk lengths may be supported). The adaptive bitrate streaming process 111 is configured to request chunks of the content item 121 from the adaptive bitrate streaming server 120 wherein, for each chunk of the content item 121, the adaptive bitrate streaming process 111 may request delivery of the chunk from any of the N different content item versions 121ᵢ. The rate determination algorithm 112 is configured to determine, for each chunk of the content item 121, the particular one of the different content item versions 121ᵢ from which the chunk of the content item 121 is to be requested. The rate determination algorithm 112 may determine, for a given chunk of the content item 121 to be requested next, which one of the N different content item versions 121ᵢ from which the chunk of the content item 121 is to be requested based on a highest bitrate expected to be sustainable by the client device 110 without impacting quality of experience (QoE) of a user of the client device 110. The rate determination algorithm 112 may dynamically select higher or lower quality content item versions 121ᵢ from which to request chunks of the content item 121. In other words, the rate determination algorithm 112 may continually sense the available throughput and adapt the bitrate accordingly (e.g., selecting different content item versions 121ᵢ based on available throughput). The typical manner in which the rate determination algorithm 112 determines which one of the N different content item versions 121ᵢ from which a next chunk of the content item 121 is to be requested (e.g., based on a measure of the bandwidth available to the client device 110, based on whether or not chunks are consistently delivered in a time shorter than the interval length, based on an average of time taken by the client device 110 to download previous chunks of the content item 121, or the like, as well as various combinations thereof) will be understood by one skilled in the art. The adaptive bitrate streaming supported by client device 110 and adaptive bitrate streaming server 120 may be based on any suitable protocol, such as Hypertext Transfer Protocol (HTTP) (e.g., various implementations of which are referred to more generally as HTTP Adaptive Streaming (HAS)), HTTP Progressive Download (HTTP-PD), Real Time Streaming Protocol (RTSP), or the like. In the case of HAS, for example, the rate determination algorithm 112 of adaptive bitrate streaming process 111 may be a HAS Rate Determining Algorithm and the adaptive bitrate streaming process 111 may request chunks of content item 121 by sending HTTP GET messages to the adaptive bitrate streaming server 120. The adaptive bitrate streaming server 120 receives requests from client device 110 for chunks of content item 121 and provides the chunks of content item 121 to client device 110 from the content item versions 121ᵢ of content item 121, the particular content item version 121ᵢ being determined for each chunk. The adaptive bitrate streaming of content item 121 from adaptive bitrate streaming server 120 to client device 110 is supported via a network connection 140 established between adaptive bitrate streaming server 120 and client device 110 under control of network connection control module 118 of client device 110.

The client device 110 is configured to handle changes associated with the network connection 140 that is supporting adaptive bitrate streaming of the content item 121 from the adaptive bitrate streaming server 120 to the client device 110. The network connection 140 may be a Transmission Control Protocol (TCP) connection, a Stream Control Transmission Protocol (SCTP) connection, or any other suitable type of connection which may support delivery of a content item using adaptive bitrate streaming. The network connection control module 118 may be configured to handle network connection changes such as network address changes, access network changes, or the like, as well as various combinations thereof. The client device 110 may be configured to handle network connection changes during adaptive bitrate streaming in a manner tending to lessen or prevent degradation of user QoE for the user of the client device 110 that would otherwise normally be experienced due to network connection changes, or even in a manner for providing improvements in user QoE for the user of the client device 110. The client device 110 may be configured such that rate determination algorithm 112 and network connection change module 118 may cooperate and coordinate their actions in a manner tending to lessen or prevent degradation of user QoE for the user of the client device 110 that would otherwise normally be experienced due to network connection changes, or even in a manner for providing improvements in user QoE for the user of the client device 110.

The change associated with the network connection 140 of the client device 110 may include a change of the client device 110 from a first network address to a second network address (e.g., a change of the Internet Protocol (IP) address of the client device 110 or a change of any other address which may impact adaptive bitrate streaming of the content item 121 from the adaptive bitrate streaming server 120 to the client device 110). For example, since streaming of the content item 121 to client device 110 is expected to result in a relatively long-lived session (e.g., for downloading of video content or multimedia content), a change in the IP address of client device 110 during streaming of the content item 121 from the adaptive bitrate streaming server 120 to the client device 110 may cause poor QoE due to loss of connectivity. Additionally, even if such loss of connectivity and associated poor QoE is temporary, it may negatively affect the performance of the rate determination algorithm 112 (e.g., the rate determination algorithm 112 will detect failure of delivery of the chunk being delivered when the loss of connectivity occurs and re-request the chunk, thereby upsetting the bandwidth calculations performed by the rate determination algorithm 112) and, thus, result in jerky playout of the content item 121 at client device 110.

The change associated with the network connection 140 of the client device 110 may include a handover of the client device 110 from a first access network to a second access network (illustratively, from the communication network 130 to a communication network 131), which may result in a change of the client device 110 from a first network address to a second network address (e.g., again, a change of the IP address of the client device 110 or a change of any other address which may impact adaptive bitrate streaming of the content item 121 from the adaptive bitrate streaming server 120 to the client device 110). For example, during the lifetime of streaming of the content item 121 to client device 110, there may be a desire to change the access network that is used by the client device 110 (e.g., a WiFi network may be able to offer higher bandwidth at lower cost than an LTE network) or a need to change the access network that is used by the client device 110 (e.g., where client device 110 moves from a location of LTE coverage to an area in which only 3G wireless coverage is available). The handovers may include handovers between access points or sectors of the same access technology (e.g., 3G-3G handovers, LTE-LTE handovers, WiFi-WiFi handovers, or the like), handovers between access points or sectors of different access technologies (e.g., LTE-WiFi or WiFi-LTE handovers, 3G-WiFi or WiFi-3G handovers, LTE-3G or 3G-LTE handovers, or the like), or the like. It will be appreciated that various embodiments for handling of network connection changes during adaptive bitrate streaming may be particularly well-suited for LTE-3G handovers since such handovers may be longer than other types of wireless handovers (e.g., since the user equipment (UE) may be required to make compressed mode measurements).

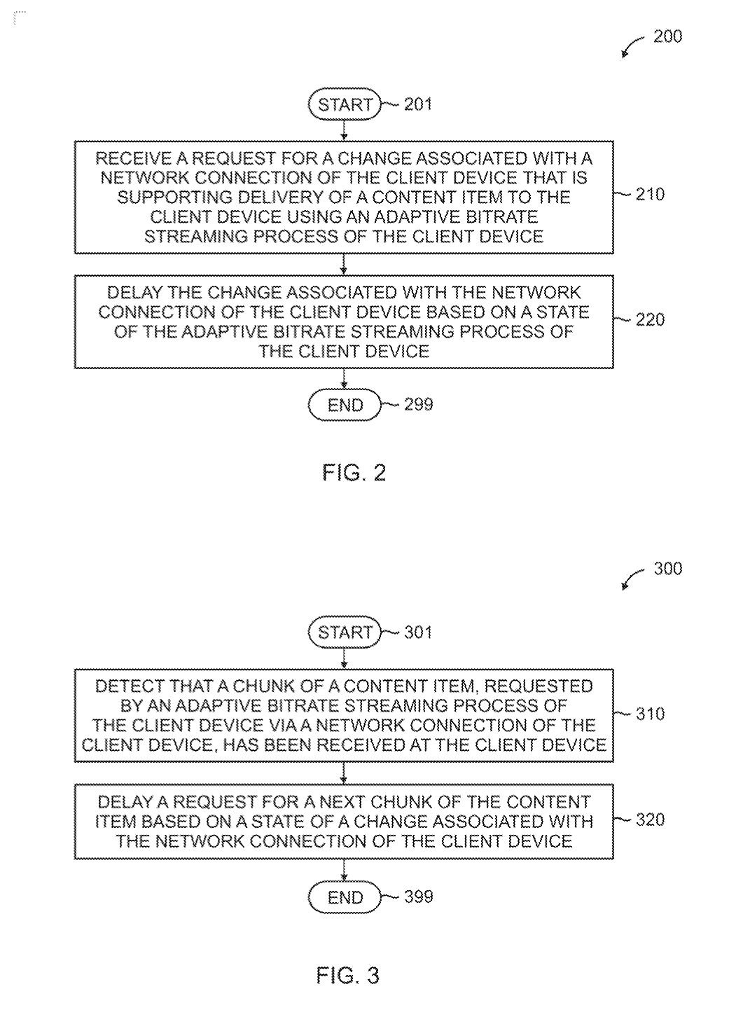

The client device 110 may be configured to receive or detect a request for a change associated with the network connection 140 of the client device 110 and determine whether or not to delay the change associated with the network connection 140 of the client device 110 based on a state of the adaptive bitrate streaming process 111 of the client device 110. The request for the change associated with the network connection 140 of the client device 110 may be detected or received locally at the client device 110 (e.g., a module of client device 110 detects that the change is necessary or desirable), received from a network device (e.g., from an access network discovery and selection function (ANDSF) server or other similar server based on policies or the like), or the like. The state of the adaptive bitrate streaming process 111 of the client device 110 may be a state of the rate determination algorithm 112. The state of the rate determination algorithm 112 may be a delivery status of the most recently requested chunk of the content item 121 (e.g., whether or not delivery of the requested chunk of the content item 121 to client device 110 is complete or in progress). The client device 110 may, based on a determination that delivery of the most recently requested chunk of the content item 121 to the client device 110 is complete, proceed with the requested change associated with the network connection 140 of the client device 110. The client device 110 may, based on a determination that delivery of the most recently requested chunk of the content item 121 to the client device 110 is not complete, delay the requested change associated with the network connection 140 of the client device 110. The client device 110 may delay the requested change associated with the network connection 140 of the client device 110 until the state of the adaptive bitrate streaming process 111 (e.g., again, the state of the rate determination algorithm 112 of the adaptive bitrate streaming process 111) is indicative that client device 110 may proceed with the requested change associated with the network connection 140 of the client device 110 (e.g., based on a determination that the most recently requested chunk of the content item 121 has been fully received by the client device 110). The client device 110 may delay the requested change associated with the network connection 140 of the client device 110 for a length of time within which it is expected or likely that delivery of the most recently requested chunk of the content item 121 to the client device 110 will be completed (e.g., determined based on information indicative of the chunk lengths of chunks of the content item 121). The client device 110 may delay the change associated with the network connection 140 of the client device 110 in various ways. For example, where the change is a change of the client device 110 from a first network address to a second network address, the client device 110 may delay the change associated with the network connection 140 by delaying obtaining of the new network address, obtaining the new network address but delaying use of the new network address, or the like. For example, where the change is a handover of the client device 110 from a first access network to a second access network, the client device 110 may delay the change associated with the network connection 140 by delaying initiation of a process for handover of the client device 110 from the first access network to the second access network, delaying completion of a process for handover of the client device 110 from a first access network to a second access network, or the like. The client device 110 may proceed with the requested change associated with the network connection 140 of the client device 110, following delay of the requested change associated with the network connection 140 of the client device 110, based on a determination that the client device 110 may proceed with the requested change associated with the network connection 140 of the client device 110 (e.g., based on a determination that the most recently requested chunk of the content item 121 has been fully received by the client device 110, expiration of a timer, or the like, as discussed above). An exemplary embodiment of a method is depicted and described with respect to FIG. 2.

The configuration of client device 110 to determine whether or not to delay the change associated with the network connection 140 of the client device 110 based on the state of the adaptive bitrate streaming process 111 of the client device 110 may be provided in various ways. The request for the change associated with the network connection 140 of the client device 110 may be detected or received by network connection control module 118, which is configured to perform or control the requested change associated with the network connection 140 of the client device 110. The state of the adaptive bitrate streaming process 111 of the client device 110 may be requested, or otherwise determined, by network change control module 118 from adaptive bitrate streaming process 111 for use by network change control module 118 in determining whether to proceed with or delay the requested change associated with the network connection 140 of the client device 110. The network change control module 118 may determine the state of the adaptive bitrate streaming process 111 of the client device 110, responsive to detecting or receiving the request for the change associated with the network connection 140 of the client device 110, before determining whether or not to delay the change associated with the network connection 140 of the client device 110. The network change control module 118 may proceed with the requested change associated with the network connection 140 of the client device 110 based on information received from the adaptive bitrate streaming process 111 (e.g., information indicative that the most recently requested chunk of the content item 121 has been fully received at client device 110). The network change control module 118 may delay the requested change associated with the network connection 140 of the client device 110 based on information received from the adaptive bitrate streaming process 111 (e.g., information indicative that the most recently requested chunk of the content item 121 has not been fully received at client device 110). The network change control module 118 may proceed with the requested change associated with the network connection 140 of the client device 110, following delay of the requested change associated with the network connection 140 of the client device 110, based on a determination that network change control module 118 may proceed with the requested change associated with the network connection 140 of the client device 110, such as based on information received from the adaptive bitrate streaming process 111 (e.g., an indication that the most recently requested chunk of the content item 121 has been delivered to the client device 110), based on detection of a condition locally at network change control module 118 (e.g., expiration of a timer started based on a request to delay the requested change associated with the network connection 140 of the client device 110), or the like. It will be appreciated that, although primarily described herein with respect to embodiments in which certain functions for determining whether to delay the change associated with the network connection 140 of the client device 110 are performed by certain elements of client device 110, various functions for determining whether to delay the change associated with the network connection 140 of the client device 110 may be distributed across elements of client device 110 in other ways.

It will be appreciated that such embodiments for determining whether or not to delay the change associated with the network connection 140 of the client device 110 based on the state of the adaptive bitrate streaming process 111 of the client device 110 enable the client device 110 to complete the delivery of the current chunk of the content item 121 without impacting the progress of delivery of the current chunk of the content item 121 and, thus, without negatively impacting operation of the rate determination algorithm 112, thereby maintaining or improving user QoE for the user of client device 110.

The client device 110 may be configured to detect that a chunk of the content item 121, requested by the adaptive bitrate streaming process 111 of the client device 110 via the network connection 140 of the client device 110, has been received at the client device 110, and determine whether or not to delay a request for a next chunk of the content item 121 based on a state of a change associated with the network connection 140 of the client device 110. The client device 110 may detect that the chunk of the content item 121 has been received at the client device 110 based on a state of the adaptive bitrate streaming process 111 of the client device 110. The state of the adaptive bitrate streaming process 111 of the client device 110 may be a state of the rate determination algorithm 112. The state of the rate determination algorithm 112 may be the delivery status of the most recently requested chunk of the content item 121 (e.g., whether or not delivery of the requested chunk of the content item 121 to client device 110 is complete). The change associated with the network connection 140 of the client device 110 may be a request for a change associated with the network connection 140 of the client device 110 that is detected or received locally at the client device 110 (e.g., a module of client device 110 detects that the change is necessary or desirable), a request for a change associated with the network connection 140 of the client device 110 that is received from a network device (e.g., from an ANDSF server or other similar server based on policies or the like), or the like. The client device 110 may, based on a determination that the change associated with the network connection 140 of the client device 110 is complete (e.g., the new network address has been obtained, the client device 110 is connected to the new network after a handover request, or the like), proceed with the request for the next chunk of the content item 121. The client device 110 may, based on a determination that the change associated with the network connection 140 of the client device 110 is not complete (e.g., the new network address has not yet been obtained, the client device 110 is not yet connected to the new network after a handover request, or the like), delay the request for the next chunk of the content item 121. The manner in which the client device 110 determines whether the change associated with the network connection 140 of the client device 110 is complete may depend on various factors (e.g., a source of the request for the change associated with the network connection 140 of the client device 110, the manner in which the client device 110 effects the delay of the change associated with the network connection 140 of the client device 110, the element of the client device 110 that is determining whether the change associated with the network connection 140 of the client device 110 is complete, or the like, as well as various combinations thereof) as discussed further below. The client device 110 may delay the request for the next chunk of the content item 121 by preventing generation or propagation of the request for the next chunk of the content item 121 by the adaptive bitrate streaming process 111 of the client device 110. The client device 110 may delay the request for the next chunk of the content item 121 until a determination is made that the change associated with the network connection 140 of the client device 110 is complete. The client device 110 may delay the request for the next chunk of the content item 121 for a length of time within which it is expected or likely that that the change associated with the network connection 140 of the client device 110 will be completed. The client device 110 may proceed with the request for the next chunk of the content item 121, following delay of the request for the next chunk of the content item 121, based on a determination that the next chunk of the content item 121 may be requested (e.g., based on a determination that the change associated with the network connection 140 of the client device 110 is complete, based on expiration of a timer associated with the length of time within which it is expected or likely that that the change associated with the network connection 140 of the client device 110 will be completed, or the like). An exemplary embodiment of a method is depicted and described with respect to FIG. 3.

The configuration of client device 110 to determine whether or not to delay the request for the next chunk of the content item 121 based on the state of the change associated with the network connection 140 of the client device 110 may be provided in various ways. The request for the change associated with the network connection 140 of the client device 110 may be detected or received by network connection control module 118. The state of the change associated with the network connection 140 of the client device 110 may be determined by the adaptive bitrate streaming process 111 based on information from network connection control module 118 (e.g., based on network connection control module 118 being configured to provide adaptive bitrate streaming process 111 with information indicative of the state of the change associated with the network connection 140 of the client device 110, based on a request from adaptive bitrate streaming process 111 to network connection control module 118, or the like, as well as various combinations thereof). For example, the network connection control module 118 may inform the adaptive bitrate streaming process 111 of the request for the change associated with the network connection 140 of the client device 110 for consideration by the adaptive bitrate streaming process 111 before requesting the next chunk of the content item 121, and the adaptive bitrate streaming process 111 may request from the network connection control module 118 the state of the change associated with the network connection 140 of the client device 110 when the adaptive bitrate streaming process 111 is ready to request the next chunk of the content item 121 (e.g., when delivery of the most recently requested chunk of the content item 121 to the client device 110 is complete) in order to determine whether or not to delay the request for the next chunk of the content item 121. For example, the adaptive bitrate streaming process 111 may delay the request for the next chunk of the content item 121, following receipt of a notification from network connection control module 118 that the change associated with the network connection 140 of the client device 110 has been requested, based on a determination that adaptive bitrate streaming process 111 has not yet received a notification from network connection control module 118 that the change associated with the network connection 140 of the client device 110 is complete. The adaptive bitrate streaming process 111 may proceed with the request for the next chunk of the content item 121 based on information received from network connection control module 118 (e.g., information indicative that the change associated with the network connection 140 of the client device 110 is complete). The adaptive bitrate streaming process 111 may delay the request for the next chunk of the content item 121 based on information received from network connection control module 118 (e.g., information indicative that the change associated with the network connection 140 of the client device 110 is not complete). The delay of the request for the next chunk of the content item 121 may be performed by the adaptive bitrate streaming process 111 of the client device 110. The adaptive bitrate streaming process 111 may delay the request for the next chunk of the content item 121 by preventing generation or propagation of the request for the next chunk of the content item 121. The adaptive bitrate streaming process 111 may delay the request for the next chunk of the content item 121 until a determination is made that the change associated with the network connection 140 of the client device 110 is complete (e.g., based on information received from network connection control module 118 that indicates that the change associated with the network connection 140 of the client device 110 is complete, such as an indication that the client device 110 is using a new network address, an indication that the client device 110 is connected to a new access network, or the like). The adaptive bitrate streaming process 111 may delay the request for the next chunk of the content item 121 for a length of time within which it is expected or likely that that the change associated with the network connection 140 of the client device 110 will be completed. The adaptive bitrate streaming process 111 may proceed with the request for the next chunk of the content item 121, following delay of the request for the next chunk of the content item 121, based on a determination that the next chunk of the content item 121 may be requested, such as based on a determination that the change associated with the network connection 140 of the client device 110 is complete (e.g., based on information received from network connection control module 118 that indicates that the change associated with the network connection 140 of the client device 110 is complete), based on detection of a condition locally at adaptive bitrate streaming process 111 (e.g., expiration of a timer started based on a determination that the request for the next chunk of the content item 121 was to be delayed), or the like. It will be appreciated that, although primarily described herein with respect to embodiments in which certain functions for determining whether to delay the request for the next chunk of the content item 121 based on the state of the change associated with the network connection 140 of the client device 110 are performed by certain elements of client device 110, various functions for determining whether to delay the request for the next chunk of the content item 121 based on the state of the change associated with the network connection 140 of the client device 110 may be distributed across elements of client device 110 in other ways.

It will be appreciated that such embodiments for determining whether or not to delay the request for the next chunk of the content item 121 based on the state of the change associated with the network connection 140 of the client device 110 enable the client device 110 to complete the change associated with the network connection 140 of the client device 110 before requesting a next chunk of the content item 121, such that operation of the rate determination algorithm 112 is not negatively impacted as a result of the change associated with the network connection 140 of the client device 110 and, thus, user QoE for the user of client device 110 may be maintained or improved. This also enables the rate determination algorithm 112 to reassess the available bandwidth of the network connection 140 before requesting the next chunk of the content item 121, thereby allowing the rate determination algorithm 112 to request that the next chunk be a higher or lower content item version 121ᵢ as appropriate.

The client device 110 may be configured to support combinations of the above-described embodiments for handling changes associated with the network connection 140 that is supporting adaptive bitrate streaming of the content item 121 from the adaptive bitrate streaming server 120 to the client device 110.

FIG. 2 depicts an exemplary embodiment of a method for handling a network connection change during adaptive bitrate streaming. The method 200 of FIG. 2 may be used by a client device to handle a network connection change during adaptive bitrate streaming. It will be appreciated that, although primarily presented herein as being performed serially, at least a portion of the steps of method 200 may be performed contemporaneously or in a different order than as presented in FIG. 2. At step 201, method 200 begins. At step 210, a request for a change associated with a network connection of the client device, which is supporting delivery of a content item to the client device using an adaptive bitrate streaming process of the client device, is received. At step 220, the change associated with the network connection of the client device is delayed based on a state of the adaptive bitrate streaming process of the client device. At step 299, method 200 ends. It will be appreciated that the steps of method 200, as well as various related steps or associated sub-steps, may be further understood by way of reference to the description of FIG. 1.

FIG. 3 depicts an exemplary embodiment of a method for handling a network connection change during adaptive bitrate streaming. The method 300 of FIG. 3 may be used by a client device to handle a network connection change during adaptive bitrate streaming. It will be appreciated that, although primarily presented herein as being performed serially, at least a portion of the steps of method 300 may be performed contemporaneously or in a different order than as presented in FIG. 3. At step 301, method 300 begins. At step 310, receipt of a chunk of a content item, requested by an adaptive bitrate streaming process of the client device via a network connection of the client device, at the client device is detected. At step 320, a request for a next chunk of the content item is delayed based on a state of a change associated with the network connection of the client device. At step 399, method 300 ends. It will be appreciated that the steps of method 300, as well as various related steps or associated sub-steps, may be further understood by way of reference to the description of FIG. 1.

Referring again to FIG. 1, it will be appreciated that implementation of embodiments of the capability for handling network connection changes during adaptive bitrate streaming may be provided in various ways. In at least some embodiments, for example, embodiments of the capability for handling network connection changes during adaptive bitrate streaming may be provided using interaction between an adaptive bitrate streaming client on the client device 110 (e.g., implementing functions of adaptive bitrate streaming process 111 and associated rate determination algorithm 112) and an operating system (OS) of the client device 110 (e.g., implementing functions of network connection control module 118). For example, handling of a network connection change during adaptive bitrate streaming may include: (1) the adaptive bitrate streaming client receives data of the requested chunk of the content item 121 from a socket of the OS, (2) the OS determines that it is time to change from a current network to a new network (e.g., the OS receives an indicator from an ANDSF, the OS detects a stronger WiFi or LTE signal nearby which it is authorized to use, or the like), (3) the OS issues a socket exception (e.g., using a new socket error code such as EIPAddressChange or any other suitable error code) indicative that the IP address is about to change, (4) the adaptive bitrate streaming client receives the socket exception and issues a request (e.g., iotcl( ) request or other suitable request) for delay of the IP address change, (5) the OS receives the request for delay of the IP address change and delays the IP address change, (6) the adaptive bitrate streaming client receives the rest of the requested chunk of the content item 121 from a socket of the OS, (7) the adaptive bitrate streaming client issues a message (e.g., iotcl( ) message or other suitable message) indicating that changing of the IP address may proceed, (8) the OS receives the message indicating that changing of the IP address may proceed and issues a socket exception (e.g., using a new socket error code such as EIPNewAddress or any other suitable error code) indicative that the IP address is being changed and begins the process for changing the IP address, (9) the adaptive bitrate streaming client receives the socket exception indicative that the IP address is being changed and delays a request for a next data chunk of the content item 121, (10), the OS, based on a determination that the IP address change is complete, issues a socket exception (e.g., using a new socket error code such as EIPNewAddressComplete or any other suitable error code) indicative that the IP address change is complete, and (11) the adaptive bitrate streaming client receives the socket exception indicative that the IP address change is complete and issues a request for the next chunk of the content item 121. It will be appreciated that embodiments of the capability for handling network connection changes during adaptive bitrate streaming may be implemented on client device 110 in other ways.

Various embodiments of the capability for handling network connection changes during adaptive bitrate streaming provide various advantages. In at least some embodiments, the capability for handling network connection changes during adaptive bitrate streaming provide significant improvements in the user QoE even during handover changes which would otherwise normally negatively impact user QoE (e.g., since handover decisions for the client device may be coordinated with the operation of the rate determination algorithm, this increases the likelihood that operation of the rate determination algorithm is not affected by temporary loss of IP connectivity by the client device). In at least some embodiments, the capability for handling network connection changes during adaptive bitrate streaming provide significant improvements in the user QoE without being prescriptive in terms of the manner in which the rate determination algorithm operates to perform functions such as monitoring conditions of the client device, selecting which version of the content item to request for the client device, and so forth. In at least some embodiments, the capability for handling network connection changes during adaptive bitrate streaming provides improvements in user QoE without requiring additional application clients on the client device. In at least some embodiments, the capability for handling network connection changes during adaptive bitrate streaming provides improvements in user QoE without requiring additional network intelligence. Various embodiments of the capability for handling network connection changes during adaptive bitrate streaming may provide various other advantages.

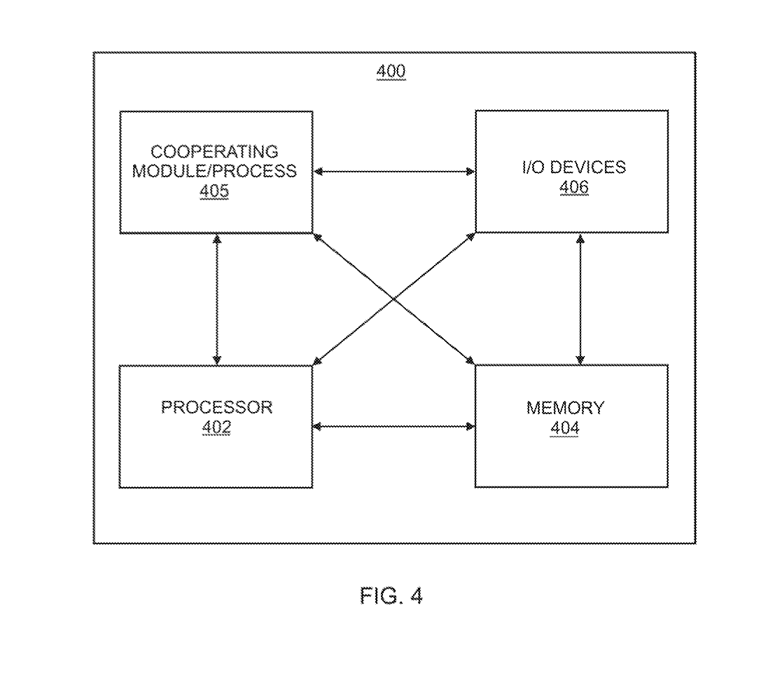

FIG. 4 depicts a high-level block diagram of a computer suitable for use in performing functions described herein.

The computer 400 includes a processor 402 (e.g., a central processing unit (CPU) and/or other suitable processor(s)) and a memory 404 (e.g., random access memory (RAM), read only memory (ROM), and the like).

The computer 400 also may include a cooperating module/process 405. The cooperating process 405 can be loaded into memory 404 and executed by the processor 402 to implement functions as discussed herein and, thus, cooperating process 405 (including associated data structures) can be stored on a computer readable storage medium, e.g., RAM memory, magnetic or optical drive or diskette, and the like.

The computer 400 also may include one or more input/output devices 406 (e.g., a user input device (such as a keyboard, a keypad, a mouse, and the like), a user output device (such as a display, a speaker, and the like), an input port, an output port, a receiver, a transmitter, one or more storage devices (e.g., a tape drive, a floppy drive, a hard disk drive, a compact disk drive, and the like), or the like, as well as various combinations thereof).

It will be appreciated that computer 400 depicted in FIG. 4 provides a general architecture and functionality suitable for implementing functional elements described herein and/or portions of functional elements described herein. For example, the computer 400 provides a general architecture and functionality suitable for implementing one or more of client device 110, a portion of client device 110, adaptive bitrate streaming server 120, a portion of adaptive bitrate streaming server 120, an element of communication network 130, an element of communication network 131, or the like.

It will be appreciated that the functions depicted and described herein may be implemented in software (e.g., via implementation of software on one or more processors, for executing on a general purpose computer (e.g., via execution by one or more processors) so as to implement a special purpose computer, and the like) and/or may be implemented in hardware (e.g., using a general purpose computer, one or more application specific integrated circuits (ASIC), and/or any other hardware equivalents).

It will be appreciated that at least some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

It will be appreciated that the term “or” as used herein refers to a non-exclusive “or,” unless otherwise indicated (e.g., use of “or else” or “or in the alternative”).

It will be appreciated that, although various embodiments which incorporate the teachings presented herein have been shown and described in detail herein, those skilled in the art can readily devise many other varied embodiments that still incorporate these teachings.

What is claimed is:

1. A client device, comprising:
a processor and a memory communicatively connected to the processor, the processor configured to:
receive a request for a change associated with a network connection of the client device, the network connection of the client device configured for supporting delivery of a content item to the client device using an adaptive bitrate streaming process of the client device; and
delay the change associated with the network connection of the client device based on a state of the adaptive bitrate streaming process of the client device.

2. The client device of claim 1, wherein the change associated with the network connection of the client device comprises at least one of a handover of the client device from a first access network to a second access network or a change of the client device from a first network address to a second network address.

3. The client device of claim 1, wherein the processor is configured to receive the request for the change associated with the network connection of the client device from a module of the client device or from a network element.

4. The client device of claim 1, wherein the state of the adaptive bitrate streaming process of the client device comprises a state of a rate determination algorithm of the adaptive bitrate streaming process of the client device.

5. The client device of claim 1, wherein the processor is configured to delay the change associated with the network connection of the client device based on a determination that the state of the rate determination algorithm of the adaptive bitrate streaming process of the client device is indicative that a chunk of the content item is being delivered to the client device.

6. The client device of claim 1, wherein the processor is configured to delay the change associated with the network connection of the client device by triggering a rate determination algorithm of the adaptive bitrate streaming process of the client device to issue, to an operating system of the client device, a command requesting delay of the change associated with the network connection of the client device.

7. The client device of claim 1, wherein the adaptive bitrate streaming process of the client device comprises a Hypertext Transfer Protocol (HTTP) Adaptive Streaming (HAS) process.

8. The client device of claim 1, wherein the processor is configured to:
initiate the change associated with the network connection of the client device based on a determination that a chunk of the content item, requested by a rate determination algorithm of the client device, has been delivered to the client device.

9. The client device of claim 1, wherein the processor is configured to:
detect that a chunk of the content item, requested by the client device via the adaptive bitrate streaming process of the client device, has been received at the client device; and
delay a request for a next chunk of the content item based on a state of the change associated with the network connection of the client device.

10. A method for use by a client device, comprising:
using a processor and a memory for:
receiving a request for a change associated with a network connection of the client device, the network connection of the client device configured for supporting delivery of a content item to the client device using an adaptive bitrate streaming process of the client device; and
delaying the change associated with the network connection of the client device based on a state of the adaptive bitrate streaming process of the client device.

11. A client device, comprising:
a processor and a memory communicatively connected to the processor, the processor configured to:
detect that a chunk of a content item, requested by an adaptive bitrate streaming process of the client device via a network connection of the client device, has been received at the client device; and
delay a request for a next chunk of the content item based on a state of a change associated with the network connection of the client device.

12. The client device of claim 11, wherein the change associated with the network connection of the client device comprises a handover of the client device from a first access network to a second access network.

13. The client device of claim 12, wherein the processor is configured to delay the request for the next chunk of the content item based on a determination that the handover of the client device from the first access network to the second access network is not complete.

14. The client device of claim 11, wherein the change associated with the network connection of the client device comprises a change of the client device from a first network address to a second network address.

15. The client device of claim 14, wherein the processor is configured to delay the request for the next chunk of the content item based on a determination that the change of the client device from the first network address to the second network address is not complete.

16. The client device of claim 14, wherein the first network address comprises a first Internet Protocol (IP) address and the second network address comprises a second IP address.

17. The client device of claim 11, wherein the adaptive bitrate streaming process of the client device comprises a Hypertext Transfer Protocol (HTTP) Adaptive Streaming (HAS) process.

18. The client device of claim 11, wherein the processor is configured to:
propagate the request for the next chunk of the content item based on a determination that the change associated with the network connection of the client device is complete.

19. The client device of claim 11, wherein the processor is configured to:
receive a request for a second change associated with the network connection of the client device; and
delay the second change associated with the network connection of the client device based on a state of the adaptive bitrate streaming process of the client device.

20. A method for use by a client device, comprising:
using a processor and a memory for:
detecting that a chunk of a content item, requested by an adaptive bitrate streaming process of the client device via a network connection of the client device, has been received at the client device; and
delaying a request for a next chunk of the content item based on a state of a change associated with the network connection of the client device.
